(19) United States
(12) Patent Application Publication
(10) Pub. No.: US 2019/0340995 A1
(43) Pub. Date: Nov. 7, 2019

(54) DISPLAY DEVICE

(71) Applicant: SHARP KABUSHIKI KAISHA, Sakai City, Osaka (JP)

(72) Inventors: HIDEKAZU MIYATA, Sakai City (JP); NORIAKI YAMAGUCHI, Sakai City (JP)

(21) Appl. No.: 16/310,785

(22) PCT Filed: Aug. 2, 2017
(86) PCT No.: PCT/JP2017/027979

§ 371 Date: Dec. 17, 2018

(30) Foreign Application Priority Data
Aug. 9, 2016 (JP) 2016-156129

(51) Int. Cl. G09G 3/36; G02F 1/1343

(52) U.S. Cl. CPC G09G 3/3688; G09G 3/3677; G02F 1/134336; G09G 2310/027; G09G 2300/0876; G09G 2310/0248; G09G 2330/027; G09G 2320/0257

(57) ABSTRACT

Periods P1 to P3 are set when a power of a liquid crystal display device 10 is turned off. In an afterimage deletion period P1, a gate line is driven similarly to a case of a normal operation, and a correction voltage obtained by adding a pull-in voltage to a voltage of a common electrode is applied to a source line. In a voltage drop period P2, a zero voltage is applied to the gate line, the source line, and the common electrode. In a charge discharging period P3, the zero voltage is applied to the source line and the common electrode, and in at least a part of the charge discharging period P3, a voltage that enables charge to move between the source line and the pixel electrode via a TFT is applied to the gate line. A voltage holding unit that, even after an input power voltage is reduced, supplies a voltage, which is almost equal to the input power voltage, until at least the period P3 ends is provided. As a result, flicker or image sticking caused when the power is turned on again is prevented.

### TECHNICAL FIELD

The present invention relates to a display device, and particularly relates to a display device of an active matrix type.

### BACKGROUND ART

A liquid crystal display device of an active matrix type has a structure in which pixel circuits each include a pixel electrode and a thin film transistor (hereinafter, abbreviated as a TFT) for writing control are arranged in a two-dimensional form. In a conventional liquid crystal display device, the TFT is formed by using, for example, amorphous silicon. In recent years, a technique of forming the TFT by using an oxide semiconductor such as IGZO (Indium Gallium Zinc Oxide) has been put into practical use. An oxide semiconductor TFT is characterized in that a leakage current during an off time is extremely smaller than that in an amorphous silicon TFT.

As related arts, PTLs 1 and 2 describe a liquid crystal display device capable of reducing an afterimage when a power is turned off. PTL 1 describes a liquid crystal display device (FIG. 15) that includes first and second control circuits. The first and second control circuits receive a D-off signal which notifies in advance that a power of the liquid crystal display device is to be turned off and cause a common electrode and a plurality of pixel electrodes that are included in a liquid crystal panel to have the same potential. PTL 2 describes a liquid crystal display device in which, after a predetermined image is displayed when a power is turned off, a gate voltage and common electrodes are turned off, and then, a power to a data line drive circuit is turned off.

### CITATION LIST

### Patent Literature

PTL 1: Japanese Unexamined Patent Application Publication No. 2003-50565

PTL 2: Japanese Unexamined Patent Application Publication No. 2001-249320

### SUMMARY OF INVENTION

### Technical Problem

In a liquid crystal display device provided with a pixel circuit that includes an oxide semiconductor TFT, when a power is turned off and then the power is turned on again, image sticking of to an image immediately before the power is turned off or flicker due to DC deviation is caused in some cases. For example, as illustrated in FIG. 16, when the power is turned off while characters are being displayed on a screen, and the power is turned on again after several hours, image sticking of the characters displayed immediately before the power is turned off is found on the screen in some cases. A reason therefor is that, since a leakage current of the oxide semiconductor TFT during an off time is extremely small, when the power is turned off while charge remains in a pixel electrode, the charge remaining in the pixel electrode is not discharged for a long time.

The liquid crystal display device described in PTL 1 causes the pixel electrodes and the common electrode to have the same potential when the power is turned off. In the liquid crystal display device described in PTL 1, however, a potential difference is actually generated between the pixel electrodes and the common electrode and charge remains in the pixel electrodes when the power is turned off. In the liquid crystal display device described in PTL 2, power of each unit is turned off in predetermined order. However, in the liquid crystal display device described in PTL 2, a voltage of the pixel electrodes fluctuates due to an influence of the order of turning off the power. Thus, a potential difference is generated between the pixel electrodes and the common electrodes and charge remains in the pixel electrodes when the power is turned off.

A reason why charge remains in a pixel electrode when a power is turned off without special contrivance after the pixel electrode and a common electrode are caused to have the same potential will be described below. FIG. 17 is an equivalent circuit diagram of a pixel circuit included in a liquid crystal panel. In a pixel circuit 80 illustrated in FIG. 17, a liquid crystal layer having a capacitance value Clc is between a pixel electrode 82 and a common electrode 83. A parasitic capacitance having a capacitance value Cgd is between the pixel electrode 82 and a gate line Gi and a parasitic capacitance having a capacitance value Csd is between the pixel electrode 82 and a source line Sj.

It is assumed that a gate high voltage of a TFT 81, which is applied to the gate line Gi, is Vgh, a gate low voltage of the TFT 81, which is applied to the gate line Gi, is Vgl (<0 V), a voltage of the common electrode 83 is Vcom, and a capacitance value of another capacitance coupled to the pixel electrode 82 is Cx. Here, it is assumed that after the voltage Vcom is applied to the pixel electrode 82, a power of each unit is dropped. Since the parasitic capacitance having the capacitance value Cgd is between the pixel electrode 82 and the gate line Gi, the voltage applied to the pixel electrode 82 is lower than a voltage applied to the source line Sj, due to pull-in (refer to FIG. 18). A pull-in voltage ΔVp is provided by the following formula (1).

ΔVp={Cgd/(Cgd+Csd+Clc+Cx)}×(Vgh−Vgl) (1)

The pull-in occurs also when no voltage is applied to the liquid crystal layer (when the pixel electrode 82 and the common electrode 83 are caused to have the same potential). In a case where liquid crystal has positive dielectric anisotropy, a capacitance value of the liquid crystal layer when no voltage is applied is C⊥. Thus, a pull-in voltage α when writing is performed into the pixel electrode 82 so that the pixel electrode 82 has the same potential as that of the common electrode 83 is provided by the following formula (2).

α={Cgd/(Cgd+Csd+C⊥+Cx)}×(Vgh−Vgl) (2)

A voltage Vsrc of the source line Sj at this time is provided by the following formula (3).

Vsrc=Vcom+α (3)

To cause the pixel electrode 82 and the common electrode 83 to have the same potential in this manner, a voltage (Vcom+α) which is higher than the common electrode voltage Vcom by α needs to be applied to the source line Sj. A value of α is typically about 1 to 2 V though it varies depending on a material of the liquid crystal.

In a case where the pixel electrode 82 and the common electrode 83 are caused to have the same potential and the power of each unit is then turned off, the voltage of the pixel electrode 82 fluctuates due to an influence of a change in a voltage of a conductive member that is capacitively-coupled to the pixel electrode 82. A voltage Vfin of the pixel electrode 82 after voltages of the gate line Gi, the source line Sj, and the common electrode 83 that are capacitively-coupled to the pixel electrode 82 change to 0V is provided by the following formula (4).

Vfin=(Cgd/Ca)×(Vcom−Vgl)−(Csd/Ca)×α (4)

In the formula (4), Ca=Cgd+Csd+Clc+Cx. A first term of the formula (4) represents an influence due to a change in the voltage of the gate line Gi and a second term of the formula (4) represents an influence due to a change in the voltage of the source line Sj.

Considered is the case where the pixel electrode 82 and the common electrode 83 are caused to have the same potential and the power is then turned off as described in PTL 1. In this case, the voltage Vfin of the pixel electrode 82 after the power is turned off is provided by the following formula (5).

Vfin=−(Cgd×Vgl+Csd×α)/Ca (5)

Thus, in the liquid crystal display device described in PTL 1, charge according to the voltage Vfin remains in the pixel electrode 82. The voltage Vfin is, for example, about −0.2 V though it depends on a parameter of a liquid crystal panel in design. The same result is obtained also when the power of each unit is dropped in any order.

With reference to FIG. 19, a problem caused by charge remaining in a pixel electrode will be described. In a liquid crystal display device provided with a pixel circuit that includes an amorphous silicon TFT, even when charge remains in a pixel electrode when a power is turned off, the remaining charge is discharged via the amorphous silicon TFT in about several seconds, so that a large problem is not caused.

On the other hand, in a liquid crystal display device provided with a pixel circuit that includes an oxide semiconductor TFT, it takes several hours to several days until charge remaining in a pixel electrode when a power is turned off is discharged via the oxide semiconductor TFT. For example, in a case where charge enough to apply a voltage of 0.2 V to a liquid crystal layer remains in the pixel electrode, the same state as a state where, after the power is turned off, a DC voltage of 0.2 V is applied to the liquid crystal layer over several hours to several days is brought.

As illustrated in FIG. 19, a liquid crystal panel has a structure in which a liquid crystal layer 86 that includes a plurality of liquid crystal molecules 87 is held between a glass substrate 84 in which the pixel electrode 82 is formed and a glass substrate 85 in which the common electrode 83 is formed. FIG. 19(a) describes a state where charge 91 and charge 92 remain in the pixel electrode 82 and the common electrode 83 after the power is turned off. FIG. 19(b) describes a state where the power is turned on again after several hours and a voltage of 0 V is applied to the liquid crystal layer 86.

When the charge 91 and the charge 92 remain in the pixel electrode 82 and the common electrode 83 as illustrated in FIG. 19(a), a DC voltage V1 is applied to the liquid crystal layer 86. Impurity ions 93 and 94 contained in the liquid crystal layer 86 are attracted to the charge 91 and the charge 92 and move to surfaces of alignment films 88 and 89. A DC voltage by the impurity ions 93 and 94 acts so as to cancel out the DC voltage V1 by the charge 91 and the charge 92.

As illustrated in FIG. 19(b), in a case where the power is turned on again after several hours, even when no voltage is applied to the liquid crystal layer 86, a DC voltage V2 is applied to the liquid crystal layer 86 by the impurity ions 93 and 94 accumulated on the surfaces of the alignment films 88 and 89. Thus, DC deviation is generated between the pixel electrode 82 and the common electrode 83 in the pixel circuit 80. When the DC deviation is generated, image sticking (display unevenness) is caused. Additionally, since an absolute value of the voltage applied to the liquid crystal layer 86 is different between a case where a positive polarity voltage is applied and a case where a negative polarity voltage is applied, flicker (flickering) is caused.

In this manner, also when no voltage is applied to the liquid crystal layer 86, the DC voltage V2 is applied to the liquid crystal layer 86 by the impurity ions 93 and 94 accumulated on the surfaces of the alignment films 88 and 89. When a gray scale voltage is written into the pixel circuit 80 after the power is turned on again, the impurity ions 93 and 94 are removed from the alignment films 88 and 89. Until then, image sticking or flicker is caused in a display screen. The aforementioned problems arise not only in the liquid crystal display device provided with the pixel circuit that includes the oxide semiconductor TFT but also in various display devices provided with a pixel circuit that includes a TFT in which a leakage current during an off time is small.

As a result, there is an object to provide a display device capable of preventing image sticking or flicker that is caused when a power is turned on again after the power is turned off.

### Solution to Problem

The aforementioned problems are able to be solved by, for example, a display device as described below. The display device is a display device of an active matrix type that includes: a display panel that includes a plurality of gate lines, a plurality of source lines, a plurality of pixel circuits each of which includes a pixel electrode and a writing control transistor, and a common electrode that holds a display medium layer between pixel electrodes and the common electrode; a voltage generation circuit that generates voltages required to drive the gate lines and the source lines and a voltage applied to the common electrode; and a drive circuit that drives the gate lines and the source lines based on the voltages generated in the voltage generation circuit, in which a voltage drop period and a charge discharging period are set when a power is turned off, a zero voltage is applied to the gate lines, the source lines, and the common electrode in the voltage drop period, the zero voltage is applied to the source lines and the common electrode in the charge discharging period, and in at least a part of the charge discharging period, a voltage that enables charge to move between the source lines and the common electrode via writing control transistors is applied to the gate lines.

The aforementioned problems are able to be solved by, for example, a driving method of a display device as described below. The driving method of the display device is a control method of a display device of an active matrix type provided with a display panel that includes a plurality of gate lines, a plurality of source lines, a plurality of pixel circuits each of which includes a pixel electrode and a writing control transistor, and a common electrode that holds a display medium layer between pixel electrodes and the common electrode, and includes the steps of: setting a voltage drop period and a charge discharging period when a power is turned off; applying a zero voltage to the gate lines, the source lines, and the common electrode in the voltage drop period, applying the zero voltage to the source lines and the common electrode in the charge discharging period, and in at least a part of the charge discharging period, applying, to the gate lines, a voltage that enables charge to move between the source lines and the common electrode via writing control transistors.

### Advantageous Effects of Invention

According to the display device or the driving method of the display device as described above, even when the zero voltage is applied to the gate lines and the source lines in the voltage drop period and therefore a potential difference is generated between pixel electrodes and the common electrode and charge remains in the pixel electrodes, the remaining charge is able to be discharged in the charge discharging period. Thus, it is possible to prevent the charge from remaining in the pixel electrodes when the power is turned off and prevent image sticking or flicker caused when the power is turned on again.

### BRIEF DESCRIPTION OF DRAWINGS

FIG. 1 is a block diagram illustrating a configuration of a liquid crystal display device according to a first embodiment.

FIG. 2 is a timing chart of a gate line drive circuit of the liquid crystal display device illustrated in FIG. 1.

FIG. 3 is a timing chart of a source line drive circuit of the liquid crystal display device illustrated in FIG. 1.

FIG. 4 illustrates details of a gray scale voltage generation circuit of the liquid crystal display device illustrated in FIG. 1.

FIG. 5 is a block diagram illustrating details of a display control circuit of the liquid crystal display device illustrated in FIG. 1.

FIG. 6 is a timing chart of the liquid crystal display device illustrated in FIG. 1 when a power is turned off.

FIG. 7 is a timing chart when an afterimage deletion period of the liquid crystal display device illustrated in FIG. 1 starts.

FIG. 8 is a timing chart when a voltage drop period of the liquid crystal display device illustrated in FIG. 1 starts.

FIG. 9 is a signal waveform chart of the voltage drop period of the liquid crystal display device illustrated in FIG. 1.

FIG. 10 is a timing chart when a charge discharging period of the liquid crystal display device illustrated in FIG. 1 starts and ends.

FIG. 11 is a timing chart of the liquid crystal display device illustrated in FIG. 1 when the power is turned off.

FIG. 12 illustrates a display screen when the power is turned on again in the liquid crystal display device illustrated in FIG. 1.

FIG. 13 is a timing chart of a liquid crystal display device according to a second embodiment when a power is turned off.

FIG. 14 is a timing chart of a liquid crystal display device according to a third embodiment when a power is turned off.

FIG. 15 is a block diagram illustrating a configuration of a liquid crystal display device described in PTL 1.

FIG. 16 illustrates a display screen when a power is turned on again in a conventional liquid crystal display device.

FIG. 17 is an equivalent circuit diagram of a pixel circuit of a liquid crystal display device.

FIG. 18 is a signal waveform chart of a liquid crystal display device.

FIG. 19 is a view for explaining a problem caused by remaining charge in a conventional liquid crystal display device.

### DESCRIPTION OF EMBODIMENTS

### First Embodiment

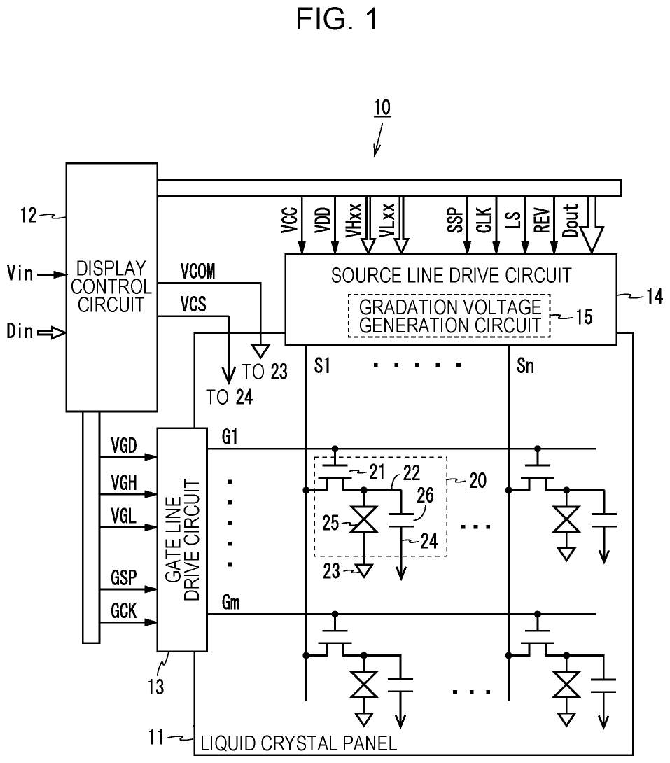

FIG. 1 is a block diagram illustrating a configuration of a liquid crystal display device according to a first embodiment. A liquid crystal display device 10 illustrated in FIG. 1 is a display device of an active matrix type. The liquid crystal display device 10 includes a liquid crystal panel 11, a display control circuit 12, a gate line drive circuit 13, and a source line drive circuit 14. Hereinafter, it is assumed that m and n are integers not smaller than 2, i is an integer not smaller than 1 and not larger than m, and j is an integer not smaller than 1 and not larger than n.

The liquid crystal panel 11 includes m gate lines G1 to Gm, n source lines S1 to Sn, and (m×n) pixel circuits 20. The gate lines G1 to Gm are arranged in parallel to each other. The source lines S1 to Sn are arranged, in a wiring layer different from that of the gate lines G1 to Gm, in parallel to each other so as to be orthogonal to the gate lines G1 to Gm. The gate lines G1 to Gm and the source lines S1 and Sn intersect at (m×n) points. The pixel circuits 20 are provided near intersections. Note that, a gate line is also called a scanning line and a source line is also called a data line.

A pixel circuit 20 includes a TFT 21 for writing control and a pixel electrode 22. In a pixel circuit 20 in an i-th row and a j-th column, a gate terminal of the TFT 21 is connected to a gate line Gi, a source terminal of the TFT 21 is connected to a source line Sj, and a drain terminal of the TFT 21 is connected to the pixel electrode 22.

The liquid crystal panel 11 has a structure in which a liquid crystal layer that contains a plurality of liquid crystal molecules is held between two glass substrates (refer to FIG. 19). In one of the glass substrates, the gate line Gi, the source line Sj, the pixel circuit 20, and the like are formed. Pixel electrodes 22 are arranged in a two-dimensional form on the glass substrate. In the other glass substrate, a common electrode 23 facing all the pixel electrodes 22 and auxiliary capacitance electrodes 24 facing the respective pixel electrodes 22 are formed. Transmittance of the liquid crystal layer changes in accordance with a gray scale voltage that is applied. The liquid crystal layer functions as a display medium layer whose state (transmittance) changes in accordance with an applied voltage.

When the pixel electrode 22 and the common electrode 23 face each other with the liquid crystal layer therebetween, a liquid crystal capacitance 25 is formed in the pixel circuit 20. When the pixel electrode 22 and an auxiliary capacitance electrode 24 face each other with the liquid crystal layer therebetween, an auxiliary capacitance 26 is formed in the pixel circuit 20. To the common electrode 23, a common electrode voltage VCOM is applied from outside of the liquid crystal panel 11. To the auxiliary capacitance electrode 24, an auxiliary capacitance electrode voltage VCS is applied from outside of the liquid crystal panel 11. Note that, the liquid crystal display device 10 may not include the auxiliary capacitance electrode 24 or the auxiliary capacitance 26.

To the display control circuit 12, an input power voltage Vin and input image data Din are input from outside of the liquid crystal display device 10. The input image data Din includes a data signal that indicates an image displayed on the liquid crystal panel 11, a timing signal that defines timing of the data signal, and the like. The input image data Din may conform to, for example, a HDMI (High-Definition Multimedia Interface) standard. The HDMI is a registered trademark in Japan and other countries.

On the basis of the input image data Din, the display control circuit 12 outputs a power voltage and a timing signal to the gate line drive circuit 13 and outputs a power voltage, a timing signal, and output image data Dout to the source line drive circuit 14. The display control circuit 12 also outputs, to the liquid crystal panel 11, the common electrode voltage VCOM applied to the common electrode 23 and the auxiliary capacitance electrode voltage VCS applied to the auxiliary capacitance electrode 24. The output image data Dout is obtained by changing a format and timing of the data signal included in the input image data Din. When the output image data Dout is transferred from the display control circuit 12 to the source line drive circuit 14, an interface standard, for example, such as a mini LVDS (mini-Low Voltage Differential Signaling) standard is used. Note that, the input image data Din and the output image data Dout may have any format in the liquid crystal display device 10.

The display control circuit 12 outputs three types of power voltages VGD, VGH, and VGL and two types of timing signals GSP and GCK to the gate line drive circuit 13. The power voltage VGD is a logic power voltage that is necessary for an operation of the gate line drive circuit 13. The power voltage VGH is a voltage applied to the gate lines G1 to Gm when TFTs 21 are controlled to be in an on state. The power voltage VGL is a voltage applied to the gate lines G1 to Gm when the TFTs 21 are controlled to be in an off state (hereinafter, the former is referred to as a gate high voltage and the latter is referred to as a gate low voltage). The timing signals GSP and GCK are respectively called a gate start pulse and a gate clock. The gate start pulse GSP indicates timing to start one frame period and the gate clock GCK indicates timing to switch selection of the gate lines G1 to Gm.

The display control circuit 12 outputs a plurality of power voltages VCC, VDD, VHxx, and VLxx, four types of timing signals SSP, CLK, LS, and REV, and the output image data Dout to the source line drive circuit 14. The power voltage VCC is a logic power voltage that is necessary for an operation of the source line drive circuit 14. The power voltage VDD is an analog power voltage that is necessary for the operation of the source line drive circuit 14. The power voltage VHxx is a positive-polarity gray scale reference voltage serving as a reference of a gray scale voltage applied to the source lines S1 to Sn. The power voltage VLxx is a negative-polarity gray scale reference voltage serving as a reference of the gray scale voltage. Each of the gray scale reference voltages VHxx and VLxx includes a plurality of voltages.

The timing signals SSP, CLK, LS, and REV are respectively called a source start pulse, a source clock, a latch strobe signal, and a polarity inversion signal. The source start pulse SSP indicates timing when first data out of the output image data Dout for one row is input. The source clock CLK indicates timing to capture the output image data Dout. The latch strobe signal LS indicates timing when the gray scale voltage according to the output image data Dout for one row is applied to the source lines S1 to Sn. The polarity inversion signal REV indicates whether or not to invert polarity of the gray scale voltage applied to the source lines S1 to Sn. Note that, the display control circuit 12 may output a signal other than the signals described above. For example, instead of the source start pulse SSP and the latch strobe signal LS, the display control circuit 12 may output one signal having functions of both of them.

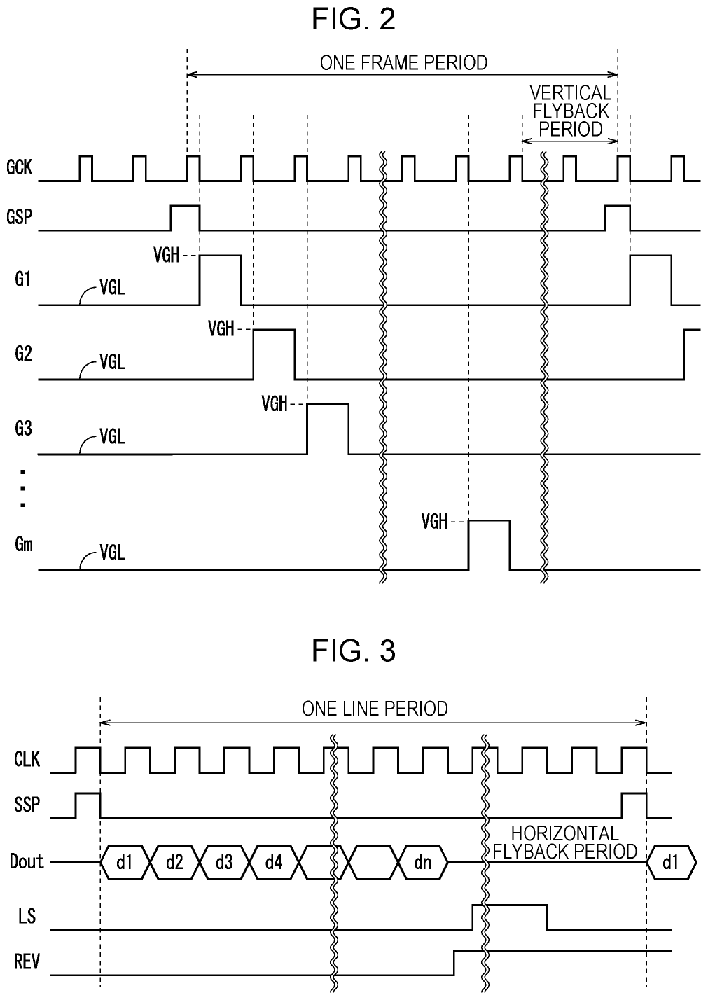

The gate line drive circuit 13 drives the gate lines G1 to Gm in accordance with the timing signals GSP and GCK output from the display control circuit 12. FIG. 2 is a timing chart of the gate line drive circuit 13. As illustrated in FIG. 2, when a level of the gate clock GCK changes from a high level to a low level while the gate start pulse GSP is at the high level, a voltage of the gate line G1 changes from VGL (gate low voltage) to VGH (gate high voltage). The voltage of the gate line G1 changes from VGH to VGL when the level of the gate clock GCK changes from the low level to the high level next time. When the level of the gate clock GCK changes from the high level to the low level next time, a voltage of the gate line G2 changes from VGL to VGH. The voltage of the gate line G2 changes from VGH to VGL when the level of the gate clock GCK changes from the low level to the high level next time. In this manner, a voltage of the gate line Gi changes from VGL to VGH when the level of the gate clock GCK changes from the high level to the low level, and changes from VGH to VGL when the level of the gate clock GCK changes from the low level to the high level next time. As a result, the gate high voltage VGH is applied to the gate lines G1 to Gm in ascending order for each predetermined time.

In FIG. 2, it is assumed that the voltages of the gate lines G1 to Gm change from VGH to VGL when the level of the gate clock GCK changes from the low level to the high level. Instead of this, the voltages of the gate lines G1 to Gm may change from VGH to VGL when the level of the gate clock GCK changes from the high level to the low level. In such a case, the display control circuit 12 outputs, to the gate line drive circuit 13, a gate enable signal GOE that indicates a period during which the gate high voltage VGH is applied to the gate lines G1 to Gm. The gate line drive circuit 13 applies the gate high voltage VGH to any of the gate lines G1 to Gm in a high level period of the gate enable signal GOE.

The source line drive circuit 14 drives the source lines S1 to Sn on the basis of the timing signals SSP, CLK, LS, and REV and the output image data Dout that are output from the display control circuit 12. FIG. 3 is a timing chart of the source line drive circuit 14. In FIG. 3, d1 to dn indicate output image data Dout corresponding to the source lines S1 to Sn, respectively. As illustrated in FIG. 3, the output image data Dout changes in accordance with the source clock CLK. The source start pulse SSP shifts to the high level only in a half cycle of the source clock CLK at a head of one line period. The source line drive circuit 14 has n registers (not illustrated) correspondingly to the source lines S1 to Sn. The source line drive circuit 14 holds, in order of the n registers, n pieces of output image data d1 to dn that are input after the source start pulse SSP shifts to the high level. After the output image data d1 to dn is input, the latch strobe signal LS shifts to the high level. At this time, the source line drive circuit 14 applies n gray scale voltages according to the output image data d1 to dn which are held in the n registers to the source lines S1 to Sn, respectively. Polarity of the gray scale voltages applied to the source lines S1 to Sn is switched every one frame period and every one line period between positive polarity and negative polarity. The polarity inversion signal REV indicates whether or not to invert the polarity of the gray scale voltages applied to the source lines S1 to Sn. The polarity of the gray scale voltages applied to the source lines S1 to Sn may be the same in one line period or may be switched between the positive polarity and the negative polarity for each of the source lines.

As described above, the output image data Dout may have any format in the liquid crystal display device 10. For example, in the mini_LVDS standard, the source clock CLK and the output image data Dout are converted into a plurality of differential pair signals and transferred. In addition, the source start pulse SSP is not used, and the latch strobe signal LS indicates the head of one line period and timing when the gray scale voltages are applied to the source lines. The liquid crystal display device 10 may transfer the output image data Dout from the display control circuit 12 to the source line drive circuit 14 by conforming to the mini_LVDS standard.

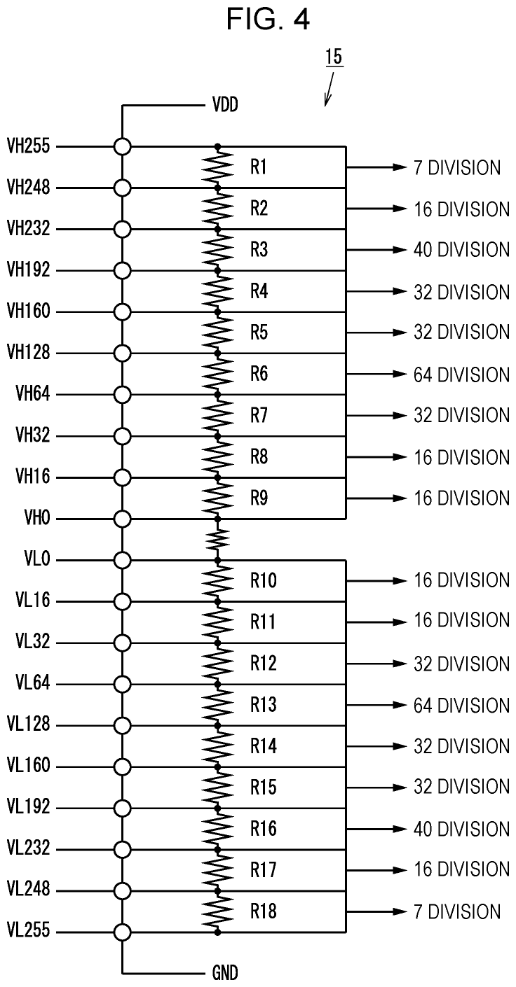

The source line drive circuit 14 includes a gray scale voltage generation circuit 15 that generates a plurality of gray scale voltages on the basis of the gray scale reference voltages VHxx and VLxx. FIG. 4 illustrates details of the gray scale voltage generation circuit 15. Here, it is assumed that the output image data Dout is 8-bit data. To the gray scale voltage generation circuit 15 illustrated in FIG. 4, 10 positive-polarity gray scale reference voltages VH0, VH16, VH32, VH64, VH128, VH160, VH192, VH232, VH248, and VH255, and 10 negative-polarity gray scale reference voltages VL0, VL16, VL32, VL64, VL128, VL160, VL192, VL232, VL248, and VL255 are input.

Different gray scale reference voltages are applied to two adjacent input terminals of the gray scale voltage generation circuit 15. A resistor (any of R1 to R18) is provided between the two adjacent terminals and output terminals (for example, seven output terminals in a case of seven division) as many as the number illustrated in FIG. 4 are provided in a middle of the resistor. In this manner, by performing resistance division, a plurality of gray scale voltages that are between two gray scale reference voltages are generated. The gray scale voltage generation circuit 15 generates 256 positive-polarity gray scale voltages on the basis of the 10 positive-polarity gray scale reference voltages and generates 256 negative-polarity gray scale voltages on the basis of the 10 negative-polarity gray scale reference voltages.

The source line drive circuit 14 applies either the positive-polarity gray scale voltage or the negative-polarity gray scale voltage to the source lines S1 to Sn in accordance with the polarity inversion signal REV and whether to be an odd-numbered source line or an even-numbered source line. For example, in a case where the output image data Dout is 144-gray scale data and the negative-polarity gray scale voltage is applied to the source line Sj, from among 512 gray scale voltages generated in the gray scale voltage generation circuit 15, the negative-polarity gray scale voltage that corresponds to 144 gray scale and is generated by using a resistor R14 which is provided between an input terminal to which the gray scale reference voltage VL128 is applied and an input terminal to which the gray scale reference voltage VL160 is applied is selected. The selected gray scale voltage is applied to the source line Sj via an output buffer circuit (not illustrated) that operates on the basis of the analog power voltage VDD.

Since a gray scale reference voltage changes in accordance with a liquid crystal material, a design value of a panel, or the like, a plurality of gray scale reference voltages are input to the gray scale voltage generation circuit 15. In a case where a gray scale voltage to be generated is obtained by resistance division, the gray scale voltage does not need to be input to the gray scale voltage generation circuit 15 as a gray scale reference voltage. For example, in a case where resistance values of all the resistors included in the gray scale voltage generation circuit 15 are able to be suitably decided, the gray scale voltage generation circuit 15 may generate 512 gray scale voltages on the basis of 4 gray scale reference voltages VH255, VH0, VL0, and VL255.

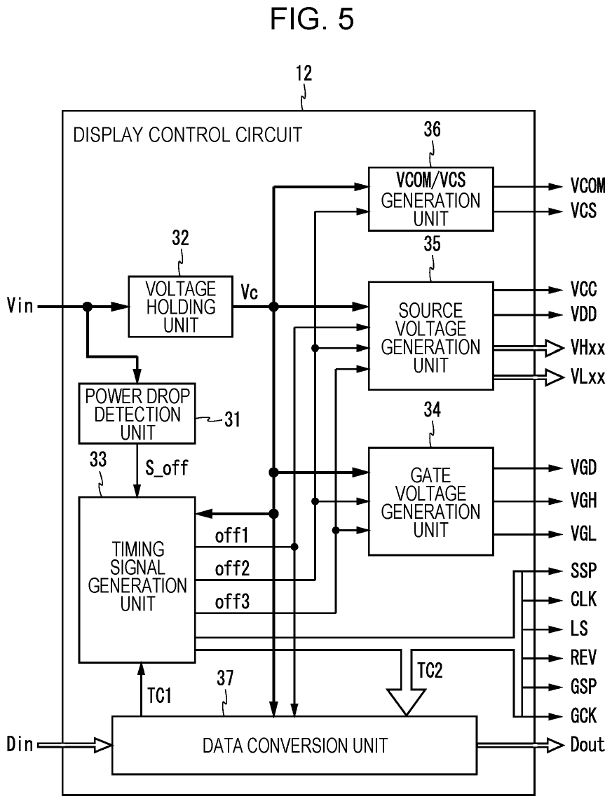

FIG. 5 is a block diagram illustrating details of the display control circuit 12. As illustrated in FIG. 5, the display control circuit 12 includes a power drop detection unit 31, a voltage holding unit 32, a timing signal generation unit 33, a gate voltage generation unit 34, a source voltage generation unit 35, a VCOM/VCS generation unit 36, and a data conversion unit 37. Hereafter, an operation in which the liquid crystal display device 10 displays an image on the liquid crystal panel 11 is referred to as a “normal operation”.

The power drop detection unit 31 monitors the input power voltage Vin input from outside of the liquid crystal display device 10. When the input power voltage Vin is dropped to a predetermined voltage or less, the power drop detection unit 31 outputs an off start signal S_off to the timing signal generation unit 33. The voltage holding unit 32 supplies a voltage Vc to each unit included in the display control circuit 12, on the basis of the input power voltage Vin. The voltage Vc is equal to the input power voltage Vin in the normal operation. The voltage holding unit 32 supplies, when the input power voltage Vin is dropped to the predetermined voltage or less, a voltage which is almost equal to the input power voltage Vin in the normal operation to each unit included in the display control circuit 12, until at least a charge discharging period (details of which will be described below) ends. To achieve such a function, the voltage holding unit 32 includes a battery, a capacitor, or the like.

The timing signal generation unit 33, the gate voltage generation unit 34, the source voltage generation unit 35, the VCOM/VCS generation unit 36, and the data conversion unit 37 operate in accordance with the voltage Vc supplied from the voltage holding unit 32. The data conversion unit 37 extracts a timing signal TC1 from the input image data Din and outputs the extracted timing signal TC1 to the timing signal generation unit 33.

On the basis of the timing signal TC1 output from the data conversion unit 37, the timing signal generation unit 33 generates the timing signals GSP and GCK for the gate line drive circuit 13, the timing signals SSP, CLK, LS, and REV for the source line drive circuit 14, and a timing signal TC2 for the data conversion unit 37. Upon reception of the off start signal S_off from the power drop detection unit 31, the timing signal generation unit 33 successively changes levels of three off control signals off1, off2, and off3 to the low level.

The gate voltage generation unit 34 generates the power voltage VGD, the gate high voltage VGH, and the gate low voltage VGL for the gate line drive circuit 13 on the basis of the voltage Vc and outputs the generated voltages to the gate line drive circuit 13. When the power is dropped, the gate voltage generation unit 34 controls levels of the gate high voltage VGH and the gate low voltage VGL in accordance with the off control signals off2 and off3.

The source voltage generation unit 35 generates the logic power voltage VCC for the source line drive circuit 14, the analog power voltage VDD for the source line drive circuit 14, the positive-polarity gray scale reference voltage VHxx, and the negative-polarity gray scale reference voltage VLxx on the basis of the voltage Vc and outputs the generated voltages to the source line drive circuit 14. When the power is dropped, the source voltage generation unit 35 controls levels of the positive-polarity gray scale reference voltage VHxx, the negative-polarity gray scale reference voltage VLxx, and the analog power voltage VDD in accordance with the off control signals off1, off2, and off3.

The VCOM/VCS generation unit 36 generates the common electrode voltage VCOM and the auxiliary capacitance electrode voltage VCS on the basis of the voltage Vc and outputs the generated voltages to the liquid crystal panel 11. When the power is dropped, the VCOM/VCS generation unit 36 controls levels of the common electrode voltage VCOM and the auxiliary capacitance electrode voltage VCS in accordance with the off control signal off2. Hereinafter, it is assumed that the levels of the common electrode voltage VCOM and the auxiliary capacitance electrode voltage VCS are the same.

The data conversion unit 37 converts, on the basis of the voltage Vc and the timing signal TC2, a data signal included in the input image data Din to a signal of a format that is able to be output to the source line drive circuit 14, and outputs the converted data signal to the source line drive circuit 14 as the output image data Dout. When the power is dropped, the data conversion unit 37 switches the output image data Dout to have a predetermined value in accordance with the off control signal off1.

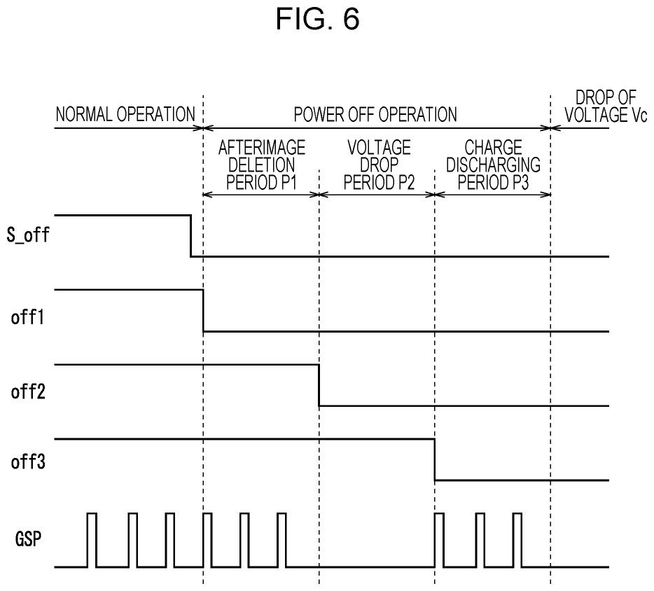

FIG. 6 is a timing chart of the liquid crystal display device 10 when the power is turned off. The liquid crystal display device 10 performs a power off operation described below to prevent charge from remaining in the pixel electrode 22 when the power is turned off. When the input power voltage Vin is dropped to a predetermined voltage or less, a level of the off start signal S_off output from the power drop detection unit 31 changes from the high level to the low level. After the level of the off start signal S_off changes to the low level, three periods (an afterimage deletion period P1, a voltage drop period P2, and the charge discharging period P3) illustrated in FIG. 6 are set. In the periods P1 to P3, the source line drive circuit 14 drives the source lines S1 to Sn similarly to the case of the normal operation. The gate line drive circuit 13 drives the gate lines G1 to Gm in the afterimage deletion period P1 and the charge discharging period P3 similarly to the case of the normal operation, but stops driving of the gate lines G1 to Gm in the voltage drop period P2. Thus, the gate start pulse GSP is fixed at the low level in the voltage drop period P2.

To the pixel electrode 22 included in the pixel circuit 20 in the i-th row and the j-th column, the gate line Gi, the source line Sj, the common electrode 23, and the auxiliary capacitance electrode 24 are capacitively-coupled. In the voltage drop period P2, the display control circuit 12 reduces voltages of the gate lines G1 to Gm, the source lines S1 to Sn, the common electrode 23, and the auxiliary capacitance electrodes 24 that are capacitively-coupled to the pixel electrodes 22 to 0 V while keeping the off state of the TFTs 21. In the charge discharging period P3, the display control circuit 12 operates the gate line drive circuit 13 and the source line drive circuit 14 to discharge charge remaining in the pixel electrodes 22. Moreover, in a case where only the voltage drop period P2 and the charge discharging period P3 are set when the power is dropped, unfavorable display (unnatural display due to voltage fluctuation in each unit) is generated in the liquid crystal panel 11 during the power off operation. Thus, the afterimage deletion period P1 is set before the voltage drop period P2 in order to prevent the unfavorable display. In the afterimage deletion period P1, the display control circuit 12 operates the gate line drive circuit 13 and the source line drive circuit 14 to delete an afterimage.

When the input power voltage Vin is dropped to a predetermined voltage or less, the power drop detection unit 31 changes the level of the off start signal S_off from the high level to the low level. The afterimage deletion period P1 starts when the level of the off start signal S_off changes to the low level. The voltage drop period P2 starts when the afterimage deletion period P1 ends. The charge discharging period P3 starts when the voltage drop period P2 ends.

When the afterimage deletion period P1 starts, the timing signal generation unit 33 changes a level of the off control signal off1 from the high level to the low level. The off control signal off1 is supplied to the source voltage generation unit 35 and the data conversion unit 37. When the voltage drop period P2 starts, the timing signal generation unit 33 changes a level of the off control signal off2 from the high level to the low level. The off control signal off2 is supplied to the gate voltage generation unit 34, the source voltage generation unit 35, and the VCOM/VCS generation unit 36. When the charge discharging period P3 starts, the timing signal generation unit 33 changes a level of the off control signal off3 from the high level to the low level. The off control signal off3 is supplied to the gate voltage generation unit 34 and the source voltage generation unit 35. When the levels of the off control signals off1, off2, and off3 change to the low level, each of the units performs control in each of the periods.

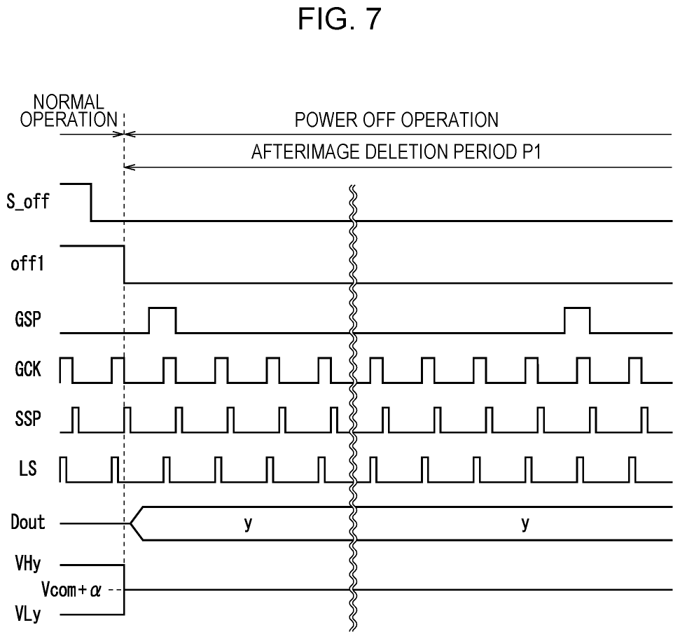

With reference to FIGS. 7 to 11, control in each of the periods will be described below. In the following description, it is assumed that the gate high voltage VGH in the normal operation is Vgh, the gate low voltage VGL in the normal operation is Vgl, the analog power voltage VDD in the normal operation is Vdd, and the common electrode voltage VCOM and the auxiliary capacitance electrode voltage VCS in the normal operation are Vcom. Note that, the gate low voltage Vgl in the normal operation is lower than 0 V.

FIG. 7 is a timing chart when the afterimage deletion period P1 starts. When the level of the off start signal S_off changes to the low level, the timing signal generation unit 33 ends the normal operation when a frame period at that time ends, and changes the level of the off control signal off1 from the high level to the low level. The timing signal generation unit 33 performs control to drive the gate lines G1 to Gm and the source lines S1 to Sn also in the afterimage deletion period P1 similarly to the case of the normal operation. More specifically, the timing signal generation unit 33 outputs the timing signals GSP and GCK for the gate line drive circuit 13, the timing signals SSP, CLK, LS, and REV for the source line drive circuit 14, and the timing signal TC2 for the date conversion unit 37 also in the afterimage deletion period P1 similarly to the case of the normal operation.

When the level of the off control signal off1 changes to the low level, the data conversion unit 37 switches the output image data Dout to have certain gray scale y in a fixed manner. The gray scale y which the output image data Dout is switched to have in this manner in the afterimage deletion period P1 is also referred to as first gray scale. The gray scale y is selected from gray scale corresponding to the gray scale reference voltages input to the gray scale voltage generation circuit 15. For example, in a case where the gray scale voltage generation circuit 15 illustrated in FIG. 4 is used, the gray scale y is selected from among 0 gray scale, 16 gray scale, 32 gray scale, 64 gray scale, 128 gray scale, 160 gray scale, 192 gray scale, 232 gray scale, 248 gray scale, and 255 gray scale.

When the level of the off control signal off1 changes to the low level, the source voltage generation unit 35 changes each of a positive-polarity gray scale reference voltage VHy and a negative-polarity gray scale reference voltage VLy according to the gray scale y among the gray scale reference voltages VHxx and VLxx to a voltage higher than the common electrode voltage Vcom in the normal operation by a pull-in voltage (more specifically, pull-in voltage when a voltage of 0 V is written into the liquid crystal layer). A pull-in voltage α at this time is provided by the following formula (6).

α={Cgd/(Cgd+Csd+C⊥+Ccs)}×(Vgh−Vgl) (6)

In the formula (6), Cgd indicates a capacitance value of a parasitic capacitance between the pixel electrode 22 and the gate line Gi, Csd indicates a capacitance value of a parasitic capacitance between the pixel electrode 22 and the source line Sj, C⊥ indicates a capacitance value (capacitance value of the liquid crystal layer) of the liquid crystal capacitance 25 when the voltage of 0 V is written into the liquid crystal layer, and Ccs indicates a capacitance value of the auxiliary capacitance 26. For example, when the gray scale y is 0 gray scale, each of levels of the positive-polarity gray scale reference voltage VH0 and the negative-polarity gray scale reference voltage VL0 according to 0 gray scale changes to a level represented by the following formula (7) in the afterimage deletion period P1.

VH0=VL0=Vcom+α (7)

Note that, when the level of the off control signal off1 changes to the low level, the source voltage generation unit 35 may change all the gray scale reference voltages VHxx and VLxx to (Vcom+α). In such a case, since the gray scale voltages generated in the gray scale voltage generation circuit 15 are all (Vcom+α), any gray scale is usable as the gray scale y.

A length of the afterimage deletion period P1 is set to an integral multiple of a frame period. The length of the afterimage deletion period P1 is set to a time longer than a longest response time in all gray scale shift, in consideration of response characteristics of the liquid crystal panel 11. This is because the capacitance value of the liquid crystal capacitance 25 is different between a case where response of the liquid crystal is not completed and a case where the response of the liquid crystal is completed, so that there is a possibility that charge remains in the pixel electrode 22 even when the power off operation is performed, in the case where the response of the liquid crystal is not completed.

In the afterimage deletion period P1, the gate line drive circuit 13 and the source line drive circuit 14 operate similarly to the case of the normal operation. However, the output image data Dout supplied to the source line drive circuit 14 is switched to have the gray scale y and a gray scale voltage according to the gray scale y changes to (Vcom+α). Thus, when the gray scale voltage according to the gray scale y is written into the pixel circuit 20, the pixel electrode 22 and the common electrode 23 have the same potential. Accordingly, a display screen in the afterimage deletion period P1 provides black display or white display that has no afterimage.

Note that, in the liquid crystal display device, there is a case where the common electrode voltage VCOM and the auxiliary capacitance electrode voltage VCS are different or a case where levels of the voltages change between a relatively high level and a relatively low level in a given cycle. In such a case, the timing signal generation unit 33 outputs the off control signal off1 also to the VCOM/VCS generation unit 36. When the level of the off control signal off1 changes to the low level, the VCOM/VCS generation unit 36 controls the common electrode voltage VCOM and the auxiliary capacitance electrode voltage VCS to be at the same level.

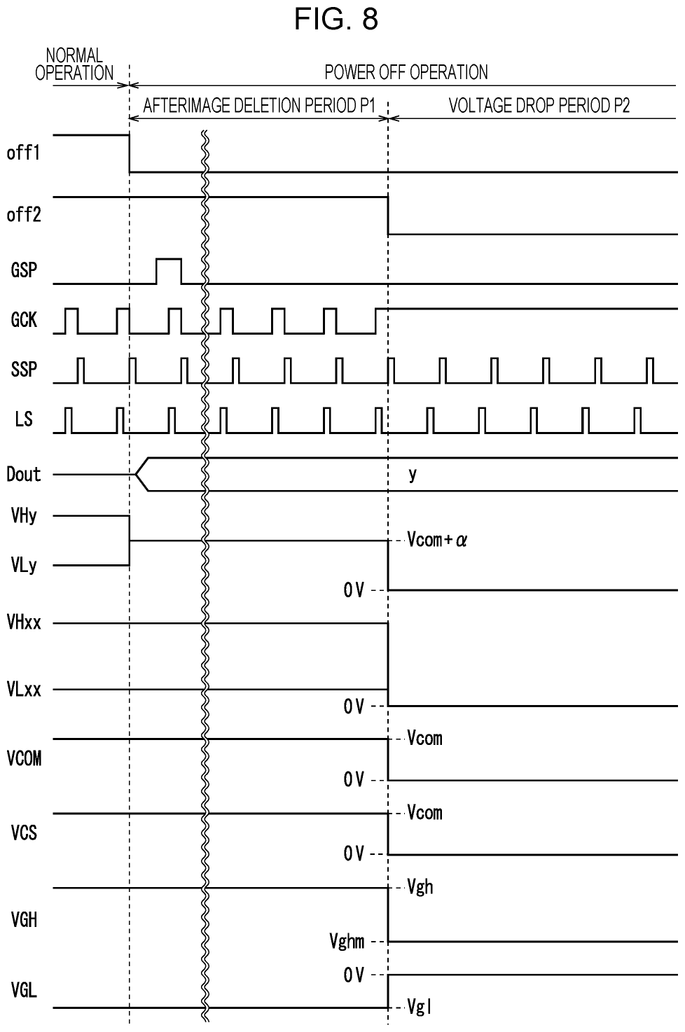

FIG. 8 is a timing chart when the voltage drop period P2 starts. When the voltage drop period P2 starts, the timing signal generation unit 33 changes the level of the off control signal off2 from the high level to the low level. Also in the voltage drop period P2, the timing signal generation unit 33 performs control to drive the source lines S1 to Sn. More specifically, also in the voltage drop period P2, the timing signal generation unit 33 outputs the timing signals SSP, CLK, LS, and REV for the source line drive circuit 14 similarly to the case of the normal operation.

In the voltage drop period P2, the timing signal generation unit 33 performs control to stop driving of the gate lines G1 to Gm. As a method of stopping driving of the gate lines G1 to Gm, there are a method of fixing the gate start pulse GSP and a method of fixing the gate clock GCK. In the present embodiment, the two methods are used in combination. More specifically, in the voltage drop period P2, the timing signal generation unit 33 fixes the gate start pulse GSP at the low level and fixes the gate clock GCK at the high level. Thus, in the voltage drop period P2, the gate line drive circuit 13 stops driving of the gate lines G1 to Gm and applies the gate low voltage VGL to the gate lines G1 to Gm. Accordingly, in the voltage drop period P2, all the TFTs 21 included in the pixel circuits 20 are in the off state.

Note that, in the voltage drop period P2, the timing signal generation unit 33 may perform at least any one of control to fix the gate start pulse GSP at the low level and control to fix the gate clock GCK at the high level. In a case where the gate line drive circuit 13 operates on the basis of the gate enable signal GOE, the timing signal generation unit 33 may fix the gate enable signal GOE at an inactive level (level at which the gate low voltage VGL is applied to a gate line) in the voltage drop period P2.

When the level of the off control signal off2 changes to the low level, the source voltage generation unit 35 changes all the gray scale reference voltages VHxx and VLxx (including VHy and VLy) to 0 V. When the level of the off control signal off2 changes to the low level, the VCOM/VCS generation unit 36 changes the common electrode voltage VCOM and the auxiliary capacitance electrode voltage VCS from Vcom to 0 V. When the level of the off control signal off2 changes to the low level, the gate voltage generation unit 34 changes the gate high voltage VGH from Vgh to Vghm and changes the gate low voltage VGL from Vgl to 0 V. In this case, the voltage Vghm is a voltage near a middle of the gate high voltage Vgh in the normal operation and 0 V.

As illustrated in FIG. 8, the gray scale reference voltages VHy and VLy change from VHy and VLy to (Vcom+α) when the afterimage deletion period P1 starts, and change from (Vcom+α) to 0 V when the voltage drop period P2 starts. The other gray scale reference voltages VHxx and VLxx change from VHxx and VLxx to 0 V when the voltage drop period P2 starts. The common electrode voltage VCOM and the auxiliary capacitance electrode voltage VCS change from Vcom to 0 V when the voltage drop period P2 starts. When the voltage drop period P2 starts, the gate high voltage VGH changes (is dropped) from Vgh to Vghm. The gate low voltage VGL changes (is boosted) from Vgl to 0 V.

In the voltage drop period P2, the TFTs 21 of all the pixel circuits 20 are in the off state and voltages of conductive members capacitively-coupled to the pixel electrodes 22 change to 0 V. The gate low voltage VGL is applied to the gate lines G1 to Gm and the gate low voltage VGL changes to 0 V, so that all the voltages of the gate lines G1 to Gm change to 0 V. Since all the gray scale reference voltages VHxx and VLxx change to 0 V, all the gray scale voltages generated in the gray scale voltage generation circuit 15 change to 0 V. Thus, all the voltages of the source lines S1 to Sn change to 0 V even when any of the gray scale voltages is applied to the source lines S1 to Sn.

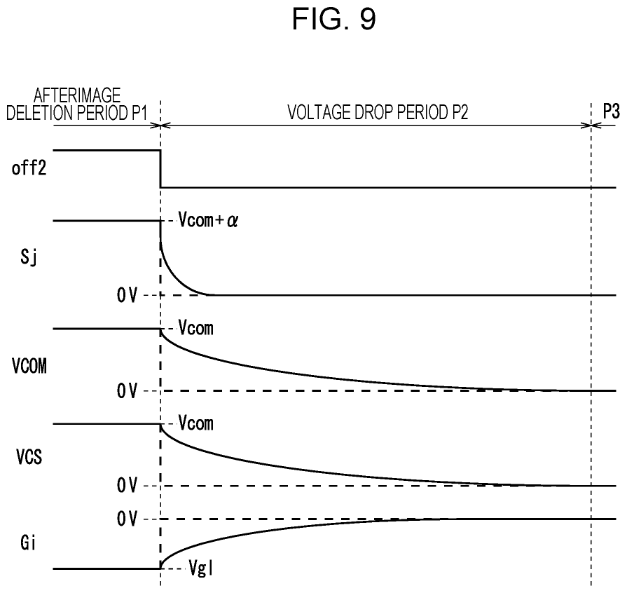

FIG. 9 is a signal waveform chart of the voltage drop period P2. In FIG. 9, a broken line indicates an ideal change of a voltage and a solid line indicates an actual change of the voltage. Though it is preferable that the voltage of each unit immediately changes to 0 V when the voltage drop period P2 starts, a certain amount of time is required till when the voltage of each unit actually reaches 0 V. When the level of the off control signal off2 changes to the low level, all the gray scale voltages generated in the gray scale voltage generation circuit 15 change to 0 V, so that the voltage of the source line Sj is dropped to 0 V. The voltage of the source line Sj is dropped to 0 V at a speed according to a magnitude of a capacitance connected to the source line Sj.

When the level of the off control signal off2 changes to the low level, the common electrode voltage VCOM and the auxiliary capacitance electrode voltage VCS that are generated in the VCOM/VCS generation unit 36 are dropped to 0 V. The liquid crystal capacitance 25, a capacitance of a wire on a circuit substrate connected to the liquid crystal panel 11, a capacitor provided on the circuit substrate, and the like are connected to the common electrode 23. Thus, the common electrode voltage VCOM and the auxiliary capacitance electrode voltage VCS are dropped to 0 V at a speed lower than that of the voltage of the source line Sj in accordance with a magnitude of capacitances connected to the common electrode 23.

When the level of the off control signal off2 changes to the low level, the gate low voltage VGL generated in the gate voltage generation unit 34 is boosted to 0 V, so that the voltage of the gate line Gi is boosted to 0 V. A large capacitance is connected also to the gate line Gi similarly to the common electrode 23. Thus, the voltage of the gate line Gi is dropped to 0 V at a speed lower than that of the voltage of the source line Sj in accordance with a magnitude of the capacitance connected to the gate line Gi.

In order for the common electrode voltage VCOM, the auxiliary capacitance electrode voltage VCS, and the voltage of the gate line Gi to reach 0 V, several frame periods are required after the voltage drop period P2 starts. In view of such a point, a length of the voltage drop period P2 is decided to be longer than a time in which the voltages (the voltages of the gate lines G1 to Gm, the voltages of the source lines S1 to Sn, the common electrode voltage VCOM, and the auxiliary capacitance electrode voltage VCS) to be changed to 0 V in the voltage drop period P2 reach almost 0 V.

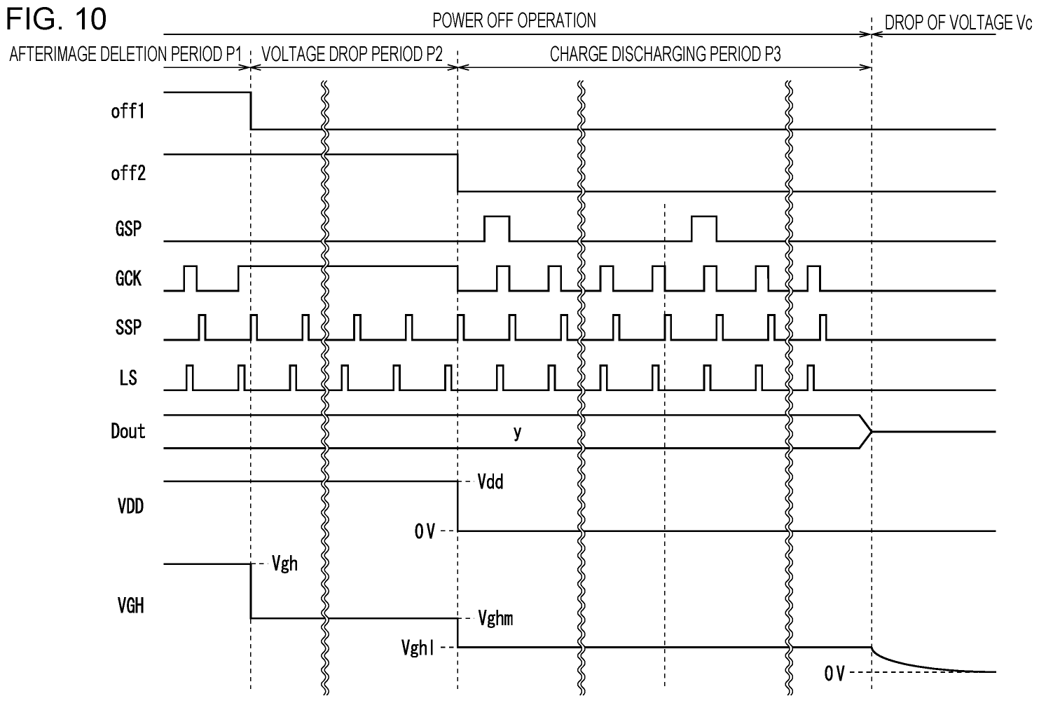

FIG. 10 is a timing chart when the charge discharging period P3 starts and ends. When the charge discharging period P3 starts, the timing signal generation unit 33 changes the level of the off control signal off3 from the high level to the low level. The timing signal generation unit 33 performs control to drive the gate lines G1 to Gm and the source lines S1 to Sn also in the charge discharging period P3 similarly to the case of the normal operation.

When the level of the off control signal off3 changes to the low level, the source voltage generation unit 35 changes the analog power voltage VDD from Vdd to 0 V. When the level of the off control signal off3 changes to the low level, the gate voltage generation unit 34 changes the gate high voltage VGH from Vghm to Vghl. In this case, it is preferable that the voltage Vghl is a voltage equal to or greater than the logic power voltage VGD of the gate line drive circuit 13 and is low as much as possible. For example, in a case where the logic power voltage VGD is 3.3 V, the voltage Vghl is set to be at a level a little higher than 3.3 V.

As illustrated in FIG. 10, the analog power voltage VDD changes from Vdd to 0 V when the charge discharging period P3 starts. The gate high voltage VGH changes from Vgh to Vghm when the voltage drop period P2 starts, and changes from Vghm to Vghl when the charge discharging period P3 starts.

A length of the charge discharging period P3 is set to be a length in which charge remaining in the pixel electrode 22 is sufficiently discharged. The length of the charge discharging period P3 is set to be two frame periods or more, and typically to be several frame periods. Note that, the length of the charge discharging period P3 is set to be two frame periods or more because the gate high voltage VGH is dropped from Vghm to Vghl in a first frame period of the charge discharging period P3.

In the charge discharging period P3, the gate line drive circuit 13 and the source line drive circuit 14 operate similarly to the case of the normal operation. Thus, in a part of the charge discharging period P3, the gate high voltage VGH that enables charge to move between the source lines S1 to Sn and the pixel electrodes 22 via the TFTs 21 is applied to the gate lines G1 to Gm. The gray scale voltage generated in the gray scale voltage generation circuit 15 is 0 V and the common electrode voltage VCOM and the auxiliary capacitance electrode voltage VCS are also 0 V. Thus, when processing for writing the gray scale voltage into the pixel circuit 20 is repeated, the potential of the pixel electrodes 22 and the potential of the common electrode 23 are gradually close to be the same and the charge remaining in the pixel electrodes 22 is gradually discharged. In addition, the gate high voltage VGH changes from Vgh to Vghm when the voltage drop period P2 starts, and changes from Vghm to Vghl when the charge discharging period P3 starts. By changing the gate high voltage VGH in this manner, a difference of a pull-in voltage when the voltage is written into the pixel circuit 20 is able to be reduced between the start and the end of the charge discharging period P3.

When the charge discharging period P3 ends, the timing signal generation unit 33 performs control to stop driving of the gate lines G1 to Gm and the source lines S1 to Sn. More specifically, when the charge discharging period P3 ends, the timing signal generation unit 33 fixes the levels of the timing signals GSP and GCK for the gate line drive circuit 13 and the levels of the timing signals SSP, CLK, LS, and REV for the source line drive circuit 14 at the low level. Thus, the gate line drive circuit 13 stops driving of the gate lines G1 to Gm and the source line drive circuit 14 stops driving of the source lines S1 to Sn.

After the charge discharging period P3 ends, the voltage Vc supplied from the voltage holding unit 32 is reduced to 0 V due to running out of a battery or the like. Accordingly, the voltage that has not reached 0 V yet among the power voltages and the signal voltages that are output from the display control circuit 12 changes to 0 V. For example, the gate high voltage VGH is Vghl when the charge discharging period P3 ends, and changes to 0 V with the voltage Vc after the charge discharging period P3 ends (refer to FIG. 10). The logic power voltage VGD of the gate line drive circuit 13 and the logic power voltage VCC of the source line drive circuit 14 also change to 0 V with the voltage Vc after the charge discharging period P3 ends.

When the power off operation ends, the voltages of the gate lines G1 to Gm, the voltages of the source lines S1 to Sn, the common electrode voltage VCOM, and the auxiliary capacitance electrode voltage VCS are all 0 V in the liquid crystal panel 11. Thus, charge is not accumulated in the pixel electrode 22 after the power off operation ends. As a result, with the liquid crystal display device 10 according to the present embodiment, it is possible to prevent charge from remaining in the pixel electrode 22 when the power is turned off.

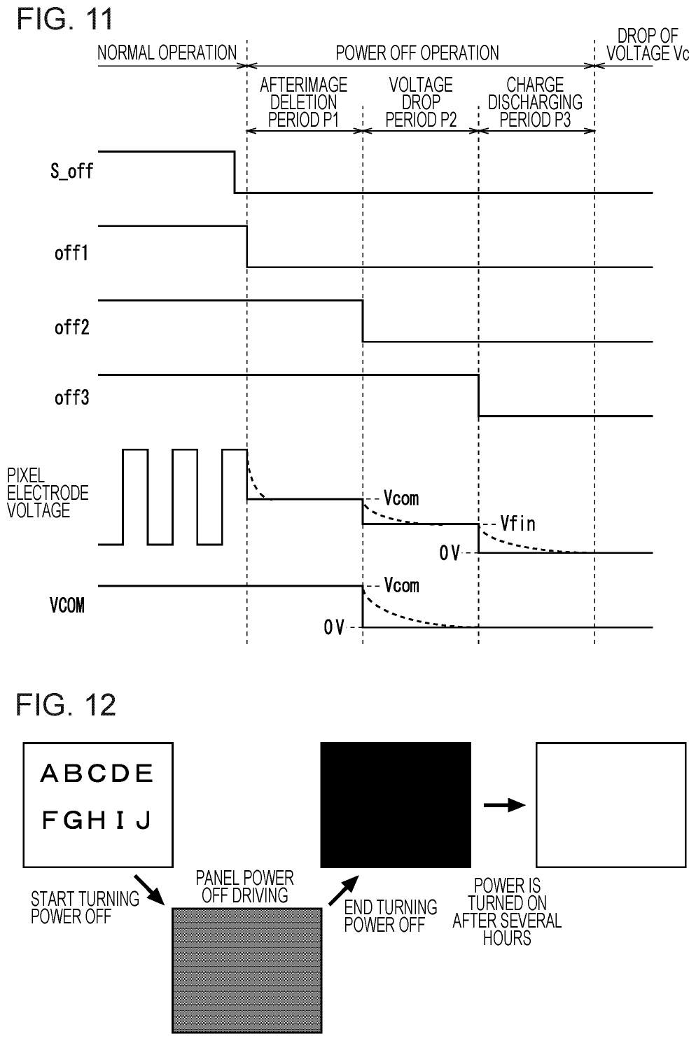

With reference to FIG. 11, a change in the voltage applied to the liquid crystal layer during the power off operation will be described. During the normal operation, a positive-polarity gray scale voltage and a negative-polarity gray scale voltage are alternately applied to the pixel electrode 22 each one frame period. The common electrode voltage Vcom in the normal operation is applied to the common electrode 23.

In the afterimage deletion period P1, the gray scale reference voltages VHy and Vy change to (Vcom+α) and the voltages of the source lines S1 to Sn are all (Vcom+α). When the voltage of the source line Sj is written into the pixel circuit 20, the voltage of the pixel electrode 22 is Vcom. As a result, the pixel electrode 22 and the common electrode 23 have the same potential.

In the voltage drop period P2, the gate low voltage VGL, the gray scale reference voltages VHxx and VLxx, the common electrode voltage VCOM, and the auxiliary capacitance electrode voltage VCS change to 0 V. At this time, since the voltages of the gate lines G1 to Gm are VGL, the TFTs 21 are in the off state and the voltages of source lines are not applied to the pixel electrodes 22 in all of the pixel circuits 20. At this time, the voltage of each of the pixel electrodes 22 fluctuates due to fluctuation of a voltage of a conductive member that is capacitively-coupled to the pixel electrode 22. A voltage Vfin of the pixel electrode 22 after the voltages of the gate line Gi, the source line Sj, the common electrode 23, and the auxiliary capacitance electrode 24 are dropped to 0 V is provided by the following formula (8).

Vfin=(Cgd/Cb)×(Vcom−Vgl)−(Csd/Cb)×α (8)

In the formula (8), Cb=Cgd+Csd+Clc+Ccs. A first term of the formula (8) represents an influence due to a change in the voltage of the gate line Gi and a second term of the formula (8) represents an influence due to a change in the voltage of the source line Sj. At this time, a potential difference between the pixel electrode 22 and the common electrode 23 is Vfin.

When the voltage drop period P2 ends, charge according to the potential difference Vfin remains in the pixel electrode 22. In the charge discharging period P3, to discharge the charge remaining in the pixel electrode 22, the gate lines G1 to Gm are successively selected and the voltage of the source line Sj is written into each of the pixel electrodes 22. At this time, the voltage of the source line Sj is 0 V. When the voltage of the source line Sj is able to be written into the pixel electrode 22 as it is, the pixel electrode 22 and the common electrode 23 have the same potential, but the voltage that is actually written into the pixel electrode 22 is reduced due to pull-in. Thus, the gate high voltage VGH is dropped from Vgh to Vghm in the voltage drop period P2 and the gate high voltage VGH is further dropped from Vghm to Vghl in the charge discharging period P3. This makes it possible to make the potential difference between the pixel electrode 22 and the common electrode 23 close to 0 V while gradually reducing the pull-in voltage to discharge the charge remaining in the pixel electrode 22. After the charge discharging period P3 ends, the voltage Vc output from the voltage holding unit 32 is dropped, and the logic power voltage VGD of the gate line drive circuit 13 and the logic power voltage VCC of the source line drive circuit 14 are also dropped to 0 V accordingly.

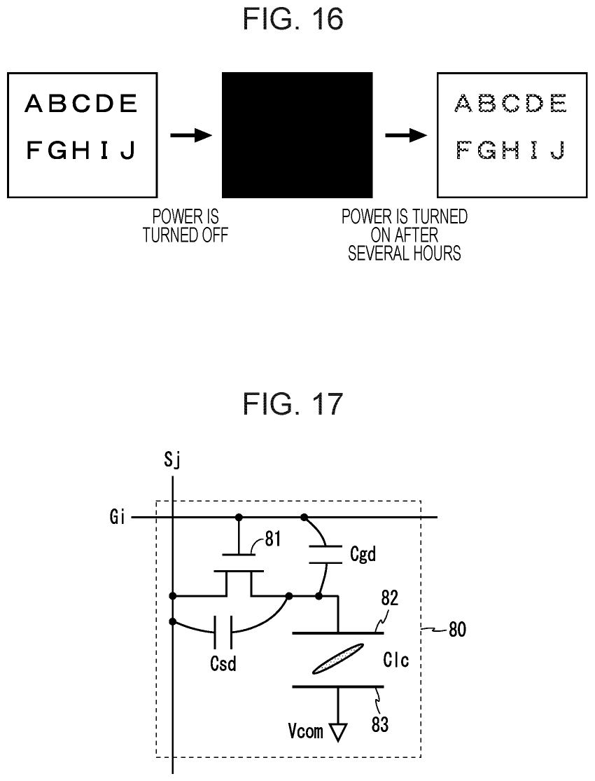

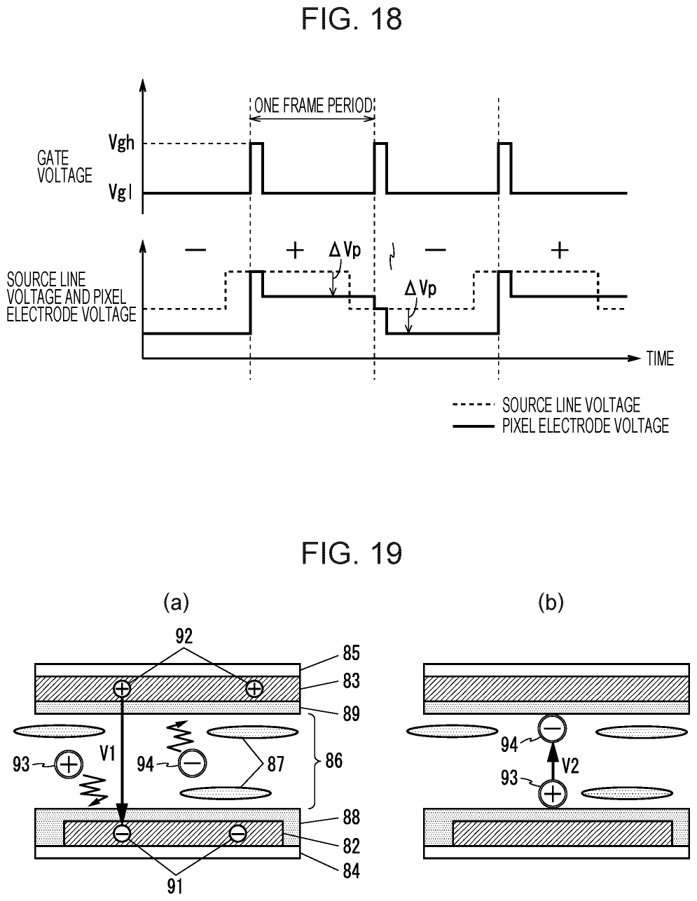

In a conventional liquid crystal display device, there is a case where unpleasant display or an afterimage is found when a power is turned off. There is also a case where, when the power is turned on again, flicker is found or a character displayed immediately before the power is turned off is found being sticking to a screen (refer to FIG. 16). In particular, in a see-through liquid crystal display device provided with a normally-white liquid crystal panel, a display screen is brought into a transmissive state when a power is turned off, so that unpleasant display or an afterimage caused when the power is turned off becomes more conspicuous than in other liquid crystal display devices.

With the liquid crystal display device 10 according to the present embodiment, by performing the power off operation described above, it is possible to prevent unpleasant display or an afterimage caused when the power is turned off and prevent image sticking or flicker caused when the power is turned on again, as illustrated in FIG. 12.

As described above, the liquid crystal display device 10 according to the present embodiment includes: a display panel (liquid crystal panel 11) that includes the plurality of gate lines G1 to Gm, the plurality of source lines S1 to Sn, the plurality of pixel circuits 20 each of which includes the pixel electrode 22 and a writing control transistor (TFT 21), and the common electrode 23 that holds a display medium layer (liquid crystal layer) between the pixel electrode 22 and the common electrode 23; a voltage generation circuit (gate voltage generation unit 34, source voltage generation unit 35, VCOM/VCS generation unit 36) that generates the voltages (power voltages VGD, VGH, VGL, VCC, VDD, VHxx, VLxx) required to drive the gate lines G1 to Gm and the source lines S1 to Sn and the voltage VCOM applied to the common electrode 23; and a drive circuit (gate line drive circuit 13, source line drive circuit 14) that drives the gate lines G1 to Gm and the source lines S1 to Sn on the basis of the voltages generated in the voltage generation circuit. In the liquid crystal display device 10, the voltage drop period P2 and the charge discharging period P3 are set when a power is turned off, and a zero voltage is applied to the gate lines G1 to Gm, the source lines S1 to Sn, and the common electrode 23 in the voltage drop period P2. The zero voltage is applied to the source lines S1 to Sn and the common electrode 23 in the charge discharging period P3, and the voltage Vghl that enables charge to move between the source lines S1 to Sn and the pixel electrodes 22 via writing control transistors is applied to the gate lines G1 to Gm once in one frame period.

Thus, with the liquid crystal display device 10 according to the present embodiment, even when the zero voltage is applied to the gate lines G1 to Gm and the source lines S1 to Sn in the voltage drop period P2 and therefore a potential difference is generated between the pixel electrodes 22 and the common electrode 23 and charge remains in the pixel electrodes 22, the remaining charge is able to be discharged in the charge discharging period P3. Thus, it is possible to prevent the charge from remaining in the pixel electrodes 22 when the power is turned off and prevent image sticking or flicker caused when the power is turned on again.

Moreover, the liquid crystal display device 10 includes a voltage holding circuit (voltage holding unit 32) that, when the input power voltage Vin is reduced, supplies the voltage Vc, which is almost equal to the input power voltage Vin, until at least the charge discharging period P3 ends. In this manner, by providing the voltage holding circuit in the liquid crystal display device 10, processing for discharging the charge remaining in the pixel electrodes 22 is able to be reliably performed even after the input power voltage Vin is reduced.

Moreover, the drive circuit drives the gate lines G1 to Gm in the charge discharging period P3 similarly to the case of the normal operation. In this manner, by driving the gate lines G1 to Gm similarly to the case of the normal operation while applying the zero voltage to the source lines S1 to Sn in the charge discharging period P3, it is possible to discharge the charge remaining in the pixel electrodes 22 to the source lines S1 to Sn via the writing control transistors and prevent the charge from remaining in the pixel electrodes 22 when the power is turned off.

Moreover, the drive circuit selectively applies a gate-on voltage (gate high voltage VGH) or a gate-off voltage (gate low voltage VGL), which is generated in the voltage generation circuit, to the gate lines G1 to Gm in the normal operation. The voltage generation circuit changes a level of the gate-on voltage to a first level (voltage Vghm), which is lower than that in the normal operation, in the voltage drop period P2 and changes the level of the gate-on voltage to a second level (voltage Vghl) which is further lower than the first level in the charge discharging period P3. In this manner, by reducing the gate-on voltage in a stepwise manner, a pull-in voltage in the charge discharging period is able to be effectively reduced.

Moreover, in the liquid crystal display device 10, the afterimage deletion period P1 is set before the voltage drop period P2. The drive circuit drives the gate lines G1 to Gm in the afterimage deletion period P1 similarly to the case of the normal operation and applies, to the source lines S1 to Sn, a correction voltage (Vcom+α) obtained by adding a pull-in voltage to the voltage of the common electrode 23. In this manner, by writing the correction voltage into the pixel electrodes 22 in the afterimage deletion period P1, it is possible to perform control so that the pixel electrodes 22 and the common electrode 23 have the same potential to prevent an afterimage from being displayed when the power is turned off.

Moreover, the drive circuit applies, to the source lines S1 to Sn, a gray scale voltage based on the gray scale reference voltages VHxx and VLxx generated in the voltage generation circuit. The voltage generation circuit generates the correction voltage (Vcom+α) as gray scale reference voltages VHy and VLy according to first gray scale (gray scale y) in the afterimage deletion period P1, and the drive circuit drives the source lines S1 to Sn on the basis of a video signal Vout, which is switched to the first gray scale y, in the afterimage deletion period P1. In this manner, in the afterimage deletion period, by setting the gray scale reference voltages according to the first gray scale as the correction voltage and driving the source lines S1 to Sn on the basis of the video signal switched to the first gray scale, the correction voltage is able to be easily applied to the source lines S1 to Sn.

Moreover, the liquid crystal display device 10 includes the liquid crystal panel 11 as the display panel. Thus, the aforementioned effect is able to be achieved in a liquid crystal display device of an active matrix type. Moreover, each of the pixel circuits 20 includes the auxiliary capacitance electrode 24, and the zero voltage is applied to the auxiliary capacitance electrode 24 in the voltage drop period P2 and the charge discharging period P3. Thus, the aforementioned effect is able to be achieved in a liquid crystal display device of an active matrix type that has a pixel circuit including an auxiliary capacitance.

### Second Embodiment

A liquid crystal display device according to a second embodiment has the same configuration as that of the liquid crystal display device 10 according to the first embodiment and performs a power off operation when a power is dropped, similarly to the liquid crystal display device 10 according to the first embodiment. However, the liquid crystal display device according to the present embodiment performs different control from that of the liquid crystal display device 10 according to the first embodiment in the charge discharging period P3.

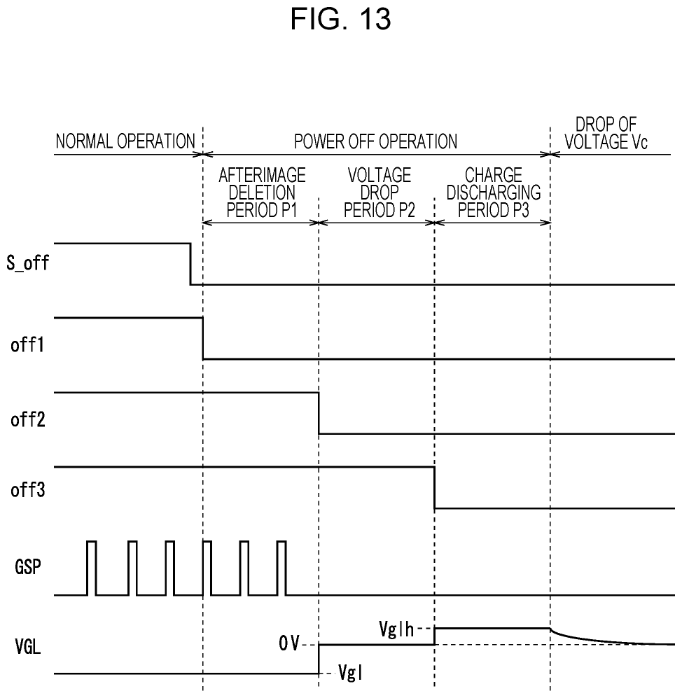

FIG. 13 is a timing chart of the liquid crystal display device according to the present embodiment when the power is turned off. The timing signal generation unit 33 according to the first embodiment performs control to drive the gate lines G1 to Gm in the charge discharging period P3. On the other hand, the timing signal generation unit 33 according to the present embodiment performs control to stop driving of the gate lines G1 to Gm also in the charge discharging period P3 similarly to the case of the voltage drop period P2. More specifically, the timing signal generation unit 33 fixes the gate start pulse GSP at the low level and fixes the gate clock GCK at the high level also in the charge discharging period P3. Thus, the gate line drive circuit 13 applies the gate low voltage VGL to the gate lines G1 to Gm also in the charge discharging period P3.

Moreover, when the level of the off control signal off3 changes to the low level, the gate voltage generation unit 34 according to the present embodiment changes the gate low voltage VGL from 0 V to Vglh. In this case, the voltage Vglh is higher than 0 V and lower than the logic power voltage VGD of the gate line drive circuit 13. The voltage Vglh is, for example, about 2 to 3 V.

In the charge discharging period P3, the voltages of the source lines S1 to Sn are 0 V and the gate low voltage VGL higher than 0 V is applied to the gate lines G1 to Gm. At this time, the voltages of the gate lines G1 to Gm are higher than the voltages of the source lines S1 to Sn. Thus, the gate low voltage VGL that enables charge to move between the source lines S1 to Sn and the pixel electrodes 22 via the TFTs 21 is applied to the gate lines G1 to Gm in the charge discharging period P3. Thus, with the liquid crystal display device according to the present embodiment, charge remaining in the pixel electrodes 22 is able to be discharged in the charge discharging period P3, similarly to the liquid crystal display device according to the first embodiment.

Note that, in the liquid crystal display device according to the present embodiment, it takes long time until the voltages of the gate lines G1 to Gm change from 0 V to Vglh in the charge discharging period P3. Moreover, it takes longer time until remaining charge is discharged in the charge discharging period P3 compared to the liquid crystal display device according to the first embodiment due to low conductivity of the TFTs 21. Thus, the length of the charge discharging period P3 needs to be decided by taking the foregoing into consideration. A battery and a capacitor that are included in the voltage holding unit 32 need to have a sufficient capacitance in accordance with the length of the charge discharging period P3.

In the liquid crystal display device according to the present embodiment, the drive circuit (gate line drive circuit 13, source line drive circuit 14) selectively applies a gate-on voltage (gate high voltage VGH) or a gate-off voltage (gate low voltage VGL), which is generated in the voltage generation circuit (gate voltage generation unit 34, source voltage generation unit 35, VCOM/VCS generation unit 36), to the gate lines G1 to Gm in the normal operation, and applies the gate-off voltage to the gate lines G1 to Gm in the charge discharging period P3. The voltage generation circuit changes a level of the gate-off voltage to a level (voltage Vglh), at which charge is able to move via the writing control transistors (TFTs 21), in the charge discharging period P3. In this manner, by applying, to the gate lines G1 to Gm, the voltage that enables charge to move via writing control transistors as the gate-off voltage in the charge discharging period P3, it is possible to discharge the charge remaining in the pixel electrodes 22 to the source lines S1 to Sn via the writing control transistors and prevent the charge from remaining in the pixel electrodes 22 when the power is turned off.

### Third Embodiment

A liquid crystal display device according to a third embodiment has the same configuration as that of the liquid crystal display device 10 according to the first embodiment and performs a power off operation when a power is dropped, similarly to the liquid crystal display device 10 according to the first embodiment. However, the liquid crystal display device according to the present embodiment performs different control from that of the liquid crystal display device 10 according to the first embodiment in the voltage drop period P2 and the charge discharging period P3.

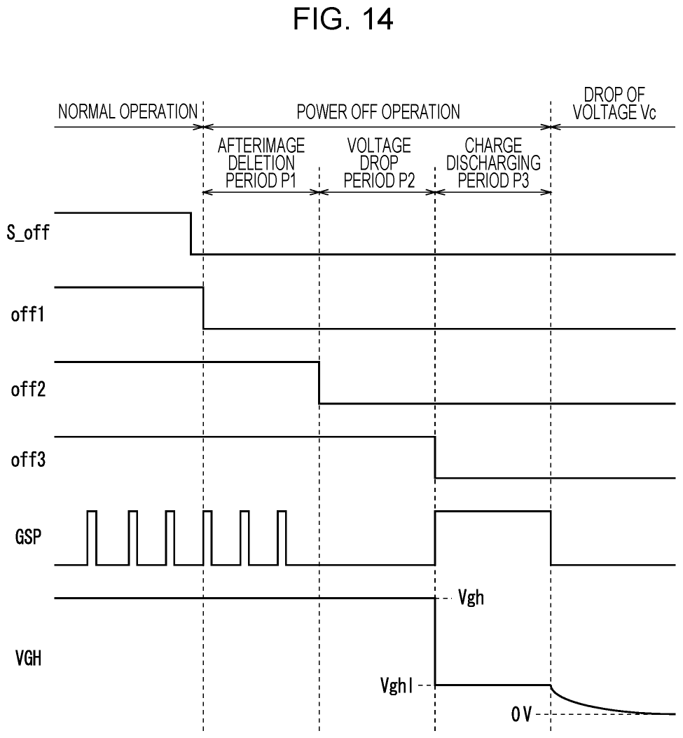

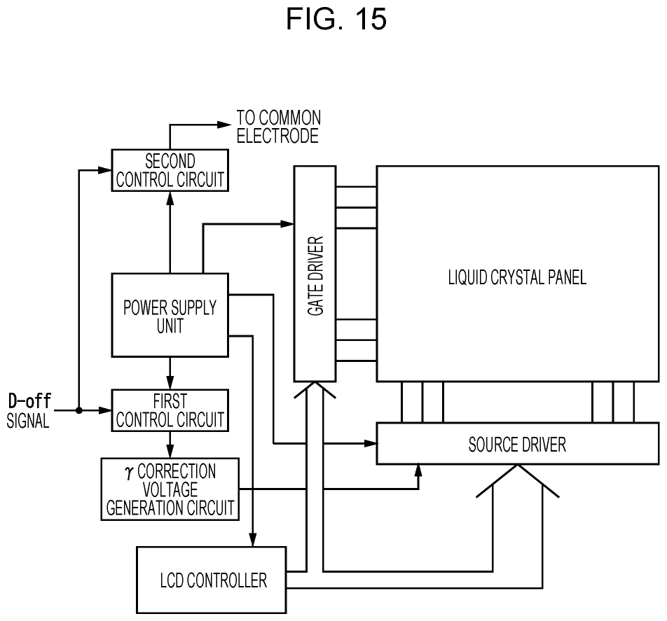

FIG. 14 is a timing chart of the liquid crystal display device according to the present embodiment when the power is turned off. The timing signal generation unit 33 according to the first embodiment outputs the gate start pulse GSP in the charge discharging period P3 similarly to the case of the normal operation. On the other hand, the timing signal generation unit 33 according to the present embodiment fixes the gate start pulse GSP at the high level in the charge discharging period P3. Thus, in the charge discharging period P3, the voltage of the gate line G1 becomes the gate high voltage VGH in a first line period, the voltages of the gate lines G1 and G2 become the gate high voltage VGH in a second line period, and the voltages of all the gate lines G1 to Gm become the gate high voltage VGH in an m-th line period.

In this manner, the gate line drive circuit 13 according to the present embodiment successively switches the voltages applied to the gate lines G1 to Gm to the gate high voltage VGH. Thus, in a part of the charge discharging period P3, the gate high voltage VGH that enables charge to move between the source lines S1 to Sn and the pixel electrodes 22 via the TFTs 21 is applied to the gate lines G1 to Gm. Accordingly, with the liquid crystal display device according to the present embodiment, charge remaining in the pixel electrodes 22 is able to be discharged in the charge discharging period P3, similarly to the liquid crystal display device according to the first embodiment.

Moreover, when the level of the off control signal off2 changes to the low level, the gate voltage generation unit 34 according to the first embodiment changes the gate high voltage VGH from Vgh to Vghm. On the other hand, when the level of the off control signal off3 changes to the low level, the gate voltage generation unit 34 according to the present embodiment changes the gate high voltage VGH from Vgh to Vghl.

In the liquid crystal display device according to the present embodiment, the drive circuit (gate line drive circuit 13, source line drive circuit 14) selectively applies a gate-on voltage (gate high voltage VGH) or a gate-off voltage (gate low voltage VGL), which is generated in the voltage generation circuit (gate voltage generation unit 34, source voltage generation unit 35, VCOM/VCS generation unit 36), to the gate lines G1 to Gm in the normal operation and successively switches voltages applied to the gate lines G1 to Gm to the gate-on voltage in the charge discharging period P3. Thereby, it is possible to discharge charge remaining in the pixel electrodes 22 to the source lines S1 to Sn via the writing control transistors (TFTs 21) to prevent the charge from remaining in the pixel electrodes 22 when the power is turned off. Moreover, since the voltages of the gate lines G1 to Gm do not change from the gate-on voltage to the gate-off voltage in the charge discharging period P3, it is possible to prevent the voltages of the pixel electrodes 22 from being reduced due to pull-in and to shorten the charge discharging period P3.

Moreover, in the charge discharging period P3, the voltage generation circuit changes a level of the gate-on voltage to a level (voltage Vghl) lower than that in the normal operation. This makes it possible to reduce a pull-in voltage in the charge discharging period P3.

Note that, in the first to third embodiments, the liquid crystal display device that performs afterimage deletion, voltage drop, and charge discharging by setting the three periods P1 to P3 when the power is turned off has been described. A liquid crystal display device according to a modified example may set two periods when a power is turned off, and perform voltage drop and charge discharging without performing afterimage deletion. In addition, by a method similar to the aforementioned method, a display device of an active matrix type (for example, organic EL display device) other than a liquid crystal display device is also able to be constituted.

As described above, a display device is a display device of an active matrix type and may include: a display panel that includes a plurality of gate lines, a plurality of source lines, a plurality of pixel circuits each of which includes a pixel electrode and a writing control transistor, and a common electrode that holds a display medium layer between pixel electrodes and the common electrode; a voltage generation circuit that generates voltages required to drive the gate lines and the source lines and a voltage applied to the common electrode; and a drive circuit that drives the gate lines and the source lines based on the voltages generated in the voltage generation circuit. A voltage drop period and a charge discharging period may be set when a power is turned off, a zero voltage may be applied to the gate lines, the source lines, and the common electrode in the voltage drop period, the zero voltage may be applied to the source lines and the common electrode in the charge discharging period, and in at least a part of the charge discharging period, a voltage that enables charge to move between the source lines and the common electrode via writing control transistors may be applied to the gate lines (first aspect).

The display device may further include a voltage holding circuit that, when an input power voltage is reduced, supplies a voltage, which is almost equal to the input power voltage, until at least the charge discharging period ends (second aspect). The drive circuit may drive the gate lines in the charge discharging period similarly to a case of a normal operation (third aspect). The drive circuit may selectively apply a gate-on voltage or a gate-off voltage, which is generated in the voltage generation circuit, to the gate lines in the normal operation, and the voltage generation circuit may change a level of the gate-on voltage to a first level, which is lower than that in the normal operation, in the voltage drop period and change the level of the gate-on voltage to a second level which is further lower than the first level in the charge discharging period (fourth aspect).

The drive circuit may selectively apply a gate-on voltage or a gate-off voltage, which is generated in the voltage generation circuit, to the gate lines in a normal operation, and apply the gate-off voltage to the gate lines in the charge discharging period, and the voltage generation circuit may change a level of the gate-off voltage to a level, at which charge is able to move via the writing control transistors, in the charge discharging period (fifth aspect).

The drive circuit may selectively apply a gate-on voltage or a gate-off voltage, which is generated in the voltage generation circuit, to the gate lines in a normal operation and successively switch voltages applied to the gate lines to the gate-on voltage in the charge discharging period (sixth aspect). The voltage generation circuit may change a level of the gate-on voltage to a level, which is lower than that in the normal operation, in the charge discharging period (seventh aspect).

An afterimage deletion period may be set before the voltage drop period, and the drive circuit may drive the gate lines in the afterimage deletion period similarly to a case of a normal operation and apply, to the source lines, a correction voltage obtained by adding a pull-in voltage to a voltage of the common electrode (eighth aspect). The drive circuit may apply, to the source lines, a gray scale voltage based on a gray scale reference voltage generated in the voltage generation circuit, the voltage generation circuit may generate the correction voltage in the afterimage deletion period as a gray scale reference voltage according to first gray scale, and the drive circuit may drive the source lines based on a video signal, which is switched to the first gray scale, in the afterimage deletion period (ninth aspect).

The display panel may be a liquid crystal panel (tenth aspect). Each of the pixel circuits may further include an auxiliary capacitance electrode, and the zero voltage may be applied to the auxiliary capacitance electrode in the voltage drop period and the charge discharging period (eleventh aspect).

A driving method of a display device is a control method of a display device of an active matrix type provided with a display panel that includes a plurality of gate lines, a plurality of source lines, a plurality of pixel circuits each of which includes a pixel electrode and a writing control transistor, and a common electrode that holds a display medium layer between pixel electrodes and the common electrode, and may include the steps of: setting a voltage drop period and a charge discharging period when a power is turned off; applying a zero voltage to the gate lines, the source lines, and the common electrode in the voltage drop period, applying the zero voltage to the source lines and the common electrode in the charge discharging period, and in at least a part of the charge discharging period, applying, to the gate lines, a voltage that enables charge to move between the source lines and the common electrode via writing control transistors (twelfth aspect).

The display device may further include a voltage holding circuit that, even after an input power voltage is reduced, supplies a voltage, which is almost equal to the input power voltage, until at least the charge discharging period ends, and the driving method of the display device may further include the steps of: generating, based on an output voltage of the voltage holding circuit, voltages required to drive the gate lines and the source lines and a voltage applied to the common electrode; and driving the gate lines and the data lines based on the voltages generated based on the output voltage of the voltage holding circuit, even after the input power voltage is reduced.

According to the first or twelfth aspect, even when the zero voltage is applied to the gate lines and the source lines in the voltage drop period and therefore a potential difference is generated between the pixel electrodes and the common electrode and charge remains in the pixel electrodes, the remaining charge is able to be discharged in the charge discharging period. Thus, it is possible to prevent the charge from remaining in the pixel electrodes when the power is turned off and prevent image sticking or flicker caused when the power is turned on again.

According to the second or thirteenth aspect, by providing the voltage holding circuit in the display device, processing for discharging the charge remaining in the pixel electrodes is able to be reliably performed even after the input power voltage is reduced. According to the third aspect, by driving the gate lines similarly to the case of the normal operation while applying the zero voltage to the source lines in the charge discharging period, it is possible to discharge the charge remaining in the pixel electrodes to the source lines via the writing control transistors and prevent the charge from remaining in the pixel electrodes when the power is turned off. According to the fourth aspect, by reducing the gate-on voltage in a stepwise manner, a pull-in voltage in the charge discharging period is able to be effectively reduced.

According to the fifth aspect, by applying, to the gate lines, the voltage that enables charge to move via the writing control transistors as the gate-off voltage in the charge discharging period, it is possible to discharge the charge remaining in the pixel electrodes to the source lines via the writing control transistors and prevent the charge from remaining in the pixel electrodes when the power is turned off.

According to the sixth aspect, by successively switching the voltage applied to the gate lines to the gate-on voltage in the charge discharging period, it is possible to discharge the charge remaining in the pixel electrodes to the source lines via the writing control transistors and prevent the charge from remaining in the pixel electrodes when the power is turned off. Moreover, since the voltages of the gate lines do not change from the gate-on voltage to the gate-off voltage in the charge discharging period, it is possible to prevent the voltages of the pixel electrodes from being reduced due to pull-in and to shorten the charge discharging period. According to the seventh aspect, by reducing the gate-on voltage in the charge discharging period compared to that in the normal operation, it is possible to reduce a pull-in voltage in the charge discharging period.

According to the eighth aspect, by writing the correction voltage into the pixel electrodes in the afterimage deletion period, it is possible to perform control so that the pixel electrodes and the common electrode have the same potential to prevent an afterimage from being displayed when the power is turned off. According to the ninth aspect, by setting the gray scale reference voltage according to the first gray scale as the correction voltage in the afterimage deletion period and driving the source lines on the basis of the video signal switched to the first gray scale, the correction voltage is able to be easily applied to the source lines.

According to the tenth aspect, in the liquid crystal display device of the active matrix type, it is possible to prevent the charge from remaining in the pixel electrodes when the power is turned off and prevent image sticking or flicker caused when the power is turned on again. According to the eleventh aspect, in the liquid crystal display device of the active matrix type that has a pixel circuit including an auxiliary capacitance, it is possible to prevent the charge from remaining in the pixel electrodes when the power is turned off and prevent image sticking or flicker caused when the power is turned on again.

The present application is an application claiming a priority based on Japanese Patent Application No. 2016-156129 filed on Aug. 9, 2016 and entitled “display device”, and the contents of this application are incorporated by reference in the present application.

### REFERENCE SIGNS LIST

10 liquid crystal display device
11 liquid crystal panel
12 display control circuit
13 gate line drive circuit
14 source line drive circuit
15 gray scale voltage generation circuit
20 pixel circuit
21 TFT
22 pixel electrode
23 common electrode
24 auxiliary capacitance electrode
25 liquid crystal capacitance
26 auxiliary capacitance
31 power drop detection unit
32 voltage holding unit
33 timing signal generation unit
34 gate voltage generation unit
35 source voltage generation unit
36 VCOM/VCS generation unit
37 data conversion unit

1. A display device of an active matrix type comprising:
a display panel that includes a plurality of gate lines, a plurality of source lines, a plurality of pixel circuits each of which includes a pixel electrode and a writing control transistor, and a common electrode that holds a display medium layer between pixel electrodes and the common electrode;
a voltage generation circuit that generates voltages required to drive the gate lines and the source lines and a voltage applied to the common electrode; and
a drive circuit that drives the gate lines and the source lines based on the voltages generated in the voltage generation circuit, wherein
a voltage drop period and a charge discharging period are set when a power is turned off,
a zero voltage is applied to the gate lines, the source lines, and the common electrode in the voltage drop period,
the zero voltage is applied to the source lines and the common electrode in the charge discharging period, and
in at least a part of the charge discharging period, a voltage that enables charge to move between the source lines and the common electrode via writing control transistors is applied to the gate lines.

2. The display device according to claim 1, further comprising a voltage holding circuit that, when an input power voltage is reduced, supplies a voltage, which is almost equal to the input power voltage, until at least the charge discharging period ends.

3. The display device according to claim 2, wherein the drive circuit drives the gate lines in the charge discharging period similarly to a case of a normal operation.

4. The display device according to claim 3, wherein
the drive circuit selectively applies a gate-on voltage or a gate-off voltage, which is generated in the voltage generation circuit, to the gate lines in the normal operation, and
the voltage generation circuit changes a level of the gate-on voltage to a first level, which is lower than that in the normal operation, in the voltage drop period and changes the level of the gate-on voltage to a second level which is further lower than the first level in the charge discharging period.

5. The display device according to claim 2, wherein
the drive circuit selectively applies a gate-on voltage or a gate-off voltage, which is generated in the voltage generation circuit, to the gate lines in a normal operation, and applies the gate-off voltage to the gate lines in the charge discharging period, and
the voltage generation circuit changes a level of the gate-off voltage to a level, at which charge is able to move via the writing control transistors, in the charge discharging period.

6. The display device according to claim 2, wherein the drive circuit selectively applies a gate-on voltage or a gate-off voltage, which is generated in the voltage generation circuit, to the gate lines in a normal operation and successively switches voltages applied to the gate lines to the gate-on voltage in the charge discharging period.

7. The display device according to claim 6, wherein the voltage generation circuit changes a level of the gate-on voltage to a level, which is lower than that in the normal operation, in the charge discharging period.

8. The display device according to claim 2, wherein
an afterimage deletion period is set before the voltage drop period, and
the drive circuit drives the gate lines in the afterimage deletion period similarly to a case of a normal operation and applies, to the source lines, a correction voltage obtained by adding a pull-in voltage to a voltage of the common electrode.

9. The display device according to claim 8, wherein
the drive circuit applies, to the source lines, a gray scale voltage based on a gray scale reference voltage generated in the voltage generation circuit,
the voltage generation circuit generates the correction voltage in the afterimage deletion period as a gray scale reference voltage according to first gray scale, and
the drive circuit drives the source lines based on a video signal, which is switched to the first gray scale, in the afterimage deletion period.

10. The display device according to claim 1, wherein the display panel is a liquid crystal panel.

11. The display device according to claim 10, wherein
each of the pixel circuits further includes an auxiliary capacitance electrode, and
the zero voltage is applied to the auxiliary capacitance electrode in the voltage drop period and the charge discharging period.

12. A control method of a display device of an active matrix type provided with a display panel that includes a plurality of gate lines, a plurality of source lines, a plurality of pixel circuits each of which includes a pixel electrode and a writing control transistor, and a common electrode that holds a display medium layer between pixel electrodes and the common electrode, the control method comprising the steps of:
setting a voltage drop period and a charge discharging period when a power is turned off;
applying a zero voltage to the gate lines, the source lines, and the common electrode in the voltage drop period;
applying the zero voltage to the source lines and the common electrode in the charge discharging period; and
in at least a part of the charge discharging period, applying, to the gate lines, a voltage that enables charge to move between the source lines and the common electrode via writing control transistors.

13. The control method of the display device according to claim 12, wherein
the display device further includes a voltage holding circuit that, even after an input power voltage is reduced, supplies a voltage, which is almost equal to the input power voltage, until at least the charge discharging period ends, and
the control method further comprising the steps of:
generating, based on an output voltage of the voltage holding circuit, voltages required to drive the gate lines and the source lines and a voltage applied to the common electrode; and
driving the gate lines and the source lines based on the voltages generated based on the output voltage of the voltage holding circuit, even after the input power voltage is reduced.
